(19) United States
(12) Patent Application Publication
(10) Pub. No.: US 2005/0182763 A1
(43) Pub. Date: Aug. 18, 2005

(54) Apparatus and method for on-line upgrade using proxy objects in server nodes

(75) Inventor: Wen-Yang Chang, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/078,911

(22) Filed: Mar. 11, 2005

Related U.S. Application Data
(63) Continuation-in-part of application No. 10/864,191, filed on Jun. 9, 2004.
(60) Provisional application No. 60/542,105, filed on Feb. 5, 2004.

(51) Int. Cl. G06F 17/30

(52) U.S. Cl. 707/4

(57) ABSTRACT

A telecommunication device capable of handling call connections between calling devices and called devices. The telecommunication device comprises: 1) a main processing unit capable of executing a plurality of client applications, wherein each of the client applications is associated with one of the call connections; and 2) a first call application node capable of executing a first primary server application. The first primary server application comprises a first proxy object that is associated with an upgrade adaptor group and wherein the first proxy object provides services to the plurality of client applications in response to requests the plurality of client applications.

### CROSS-REFERENCE TO RELATED APPLICATIONS

The present application is a continuation-in-part (CIP) of U.S. patent application Ser. No. 10/864,191, filed Jun. 9, 2004, entitled “Apparatus and Method Using Proxy Objects for Application Resource Management in a Communication Network,” which claims priority to U.S. Provisional Patent Application Ser. No. 60/542,105, filed on Feb. 5, 2004. U.S. patent application Ser. No. 10/864,191 and U.S. Provisional Patent Application Ser. No. 60/542,105 are assigned to the assignee of the present application. The subject matter disclosed in each of U.S. Provisional Patent Application Ser. No. 60/542,105 and U.S. patent application Ser. No. 10/864,191 is hereby incorporated by reference into the present application as if fully set forth herein.

### TECHNICAL FIELD OF THE INVENTION

The present invention relates generally to telecommunications systems and, more specifically, to a method of using proxy objects to dynamically manage resources in real-time.

### BACKGROUND OF THE INVENTION

Telecommunication service providers continually try to create new markets and to expand existing markets for telecommunication services and equipment. One important way to accomplish this is to improve the performance of existing network equipment while making the equipment cheaper and more reliable. Doing this allows the service providers to reduce infrastructure and operating costs while maintaining or even increasing the capacity of their existing networks.

A conventional switch or router (or similar telecommunication device) typically contains a large switching fabric controlled by a main processing unit (MPU) that contains a large number of data processors and associated memories, often in the form of ASIC chips. Each of these MPU processors contains a call process client application for controlling the flow of control signals of a single call. Each call process client application communicates with a call process server application that controls the flow of control signals for a large number of calls.

Thus, when a particular event occurs during a phone call (e.g., the call set-up, the invocation of three-way calling, call disconnection, or the like), control signals associated with the event are relayed from the origination station to the call process client application in the switching center. This call processing client application then relays the control signals to the call process server application, which actually performs the call processing service requested by the control signals.

Unfortunately, bottlenecks may develop in large capacity systems around the call process server applications. Each call process client application must communicate with a particular piece of server hardware that is executing the call process server application. Due to the random nature of the beginnings and ends of phone calls, some servers in large systems may be near capacity and develop bottlenecks, while other servers still have plenty of adequate bandwidth. Also, a system failure in a particular piece of server hardware may result in the loss of all call processes being handled by a call process server application being executed on the failed server.

Upgrading the call process server applications in a conventional switch without interrupting existing service is extremely complicated. In some prior art systems, performing a software upgrade requires fully redundant hardware in the switch. The redundant components are split into an active side and an inactive side. Complex control software is required to manage the split (by swapping active and inactive sides) and to manage the merging of the two halves of the system into a unitary system. The redundant hardware increases the cost of a conventional switch and the complex control software is expensive to develop, susceptible to errors due to its complexity, and difficult to maintain.

U.S. patent application Ser. No. 10/039,186, filed Dec. 31, 2001, entitled “System And Method For Distributed Call Processing Using A Distributed Trunk Idle List”, disclosed improved switching devices that use mapped resource groups to distribute a variety of call processing tasks across a plurality of call application nodes (CANs) or servers. U.S. patent application Ser. No. 10/039,186 is assigned to the assignee of the present application and is hereby incorporated into the present disclosure as if fully set forth herein.

U.S. patent application Ser. No. 10/864,191, incorporated by reference above, improved upon the devices disclosed in U.S. patent application Ser. No. 10/039,186 by introducing the use of proxy objects to manage application resources in the mapped resource groups. The mapped resource groups of U.S. patent application Ser. No. 10/039,186 distribute work loads for a number of tasks, including conventional call processing (CP), identity server (IS), subscriber database (SDB), idle list server (ILS) (also called trunk idle list (TIL)). By way of example, an idle list server (ILS) mapped resource group (MRG) may distribute ILS applications across several call application nodes (CANs). Each idle list server application in a CAN manages a set of the trunk idle lists. Idle list servers may be added or taken away without having to perform any configuration. The proxy objects disclosed in U.S. patent application Ser. No. 10/864,191 are associated with each ILS application and enable the primary member of each idle list server application to communicate within other ILS applications in the mapped resource group (MRG).

The managed resources groups described in U.S. patent application Ser. No. 10/039,186 may be upgraded by having upgraded software applications join the mapped resources groups and diverting new call processing tasks to the upgraded applications. The old applications may then leave the mapped resources groups after all pending call tasks are complete and subsequently be upgraded.

However, not all tasks in a switch or router may be performed by distributed server applications in load-sharing groups, as in U.S. patent application Ser. No. 10/039,186. In many cases, a call processing task may be performed by only a single centralized server application running on a single call application node. Client applications are initialized with the single server application and send all requests to that one process. If an upgraded server application is installed on a different node (i.e., new partition), the new server application should take over all call client requests. However, the old server application in the reference partition holds all data for existing calls and services. This information cannot be transferred between call application nodes because the client applications were initialized with the old server application.

Therefore, there is a need for improved telecommunication devices that may easily undergo on-line upgrades. In particular, there is a need for a telecommunication device in which a centralized server application running on a single call application node may be upgraded as part of an on-line upgrade operation.

### SUMMARY OF THE INVENTION

The present invention provides an upgrade adaptor group (UAG) that enables the on-line upgrade of a centralized server application. Client applications form associations with proxy objects in the UAG, rather than directly with the server applications. The use of the proxy objects enables the server application to be replaced while the telecommunication device is still on-line.

To address the above-discussed deficiencies of the prior art, it is a primary object of the present invention to provide a telecommunication device capable of handling call connections between calling devices and called devices. According to an advantageous embodiment, the telecommunication device comprising: 1) a main processing unit capable of executing a plurality of client applications, wherein each of the client applications is associated with one of the call connections; and 2) a first call application node capable of executing a first primary server application, wherein the first primary server application comprises a first proxy object that is associated with an upgrade adaptor group and wherein the first proxy object provides services to the plurality of client applications in response to requests the plurality of client applications.

According to one embodiment of the present invention, the first primary server application is associated with a similar first backup server application and wherein the first primary server application and the first backup server application form a first primary-backup group in which state information associated with the first primary server application is mirrored to the first backup server application.

According to another embodiment of the present invention, the first backup server application is executed on one of the N call application nodes separate from the first call application node.

According to still another embodiment of the present invention, the first proxy object, upon joining the upgrade adaptor groups, is elected leader of the upgrade adaptor group to provide the services to the plurality of client applications.

According to yet another embodiment of the present invention, the telecommunication device further comprises a second call application node capable of executing a second primary server application, wherein the second primary server application comprises a second proxy object that is associated with the upgrade adaptor group.

According to a further embodiment of the present invention, the second proxy object, upon joining the upgrade adaptor groups, is elected leader of the upgrade adaptor group.

According to a still further embodiment of the present invention, the second proxy object provides the services to the plurality of client applications after the second proxy object is elected leader of the upgrade adaptor group.

According to a yet further embodiment of the present invention, the second proxy object migrates information from the first primary server application to the second primary server application after the second proxy object is elected leader of the upgrade adaptor group.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary telecommunication device, which uses upgrade adaptor groups to perform on-line upgrades according to the principles of the present invention;

FIG. 2 is a high-level flow diagram illustrating the use of proxy objects to perform on-line upgrades in upgrade adaptor groups according to the principles of the present invention;

FIG. 3 illustrates selected portions of an on-line upgrade operation in greater detail according to an exemplary embodiment of the present invention;

FIG. 4 illustrates selected portions of an on-line upgrade operation in greater detail according to an exemplary embodiment of the present invention;

FIG. 5 illustrates selected portions of an on-line upgrade operation in greater detail according to an exemplary embodiment of the present invention; and

FIG. 6 illustrates selected portions of an on-line upgrade operation in greater detail according to an exemplary embodiment of the present invention.

### DETAILED DESCRIPTION OF THE INVENTION

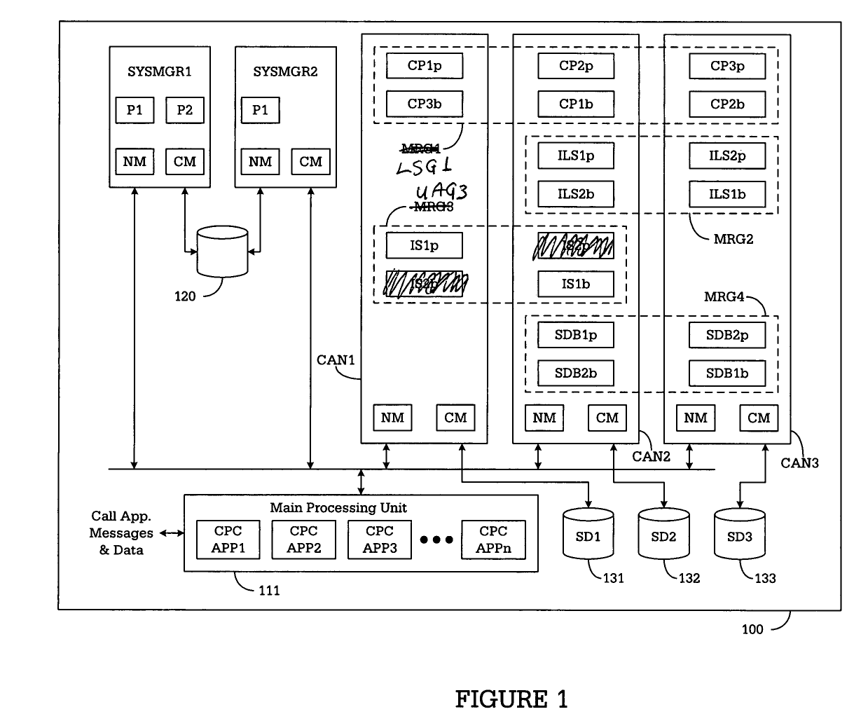

FIGS. 1 through 6, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged telecommunication device.

FIG. 1 illustrates exemplary telecommunication device 100, which uses upgrade adaptor groups to perform on-line upgrades according to the principles of the present invention. In an exemplary embodiment of the present invention, telecommunication device 100 may be, for example, a switch or a router in a wireline network, such as the public switched telephone network (PSTN). In another exemplary embodiment of the present invention, telecommunication device 100 may be a mobile switching center (MSC) of a wireless network (e.g., cell phone network) that handles call processing for mobile stations that communicate wirelessly with a plurality of base stations of the wireless network.

Telecommunication device 100 comprises main processing unit (MPU) 110, system manager node 1 (SYSMGR1), optional system manager node 2 (SYSMGR2), and master database 120. Telecommunication device 100 also comprises a plurality of call application nodes (CANs), including CAN1, CAN2, and CAN3, and a plurality of local storage devices (SDs), namely SD1, SD2, and SD3, that are associated with CAN1, CAN2 and CAN3. Master database 120 may be used as a master software repository to store databases, software images, server statistics, log-in data, and the like. SD1-SD3 may be used to store local capsules, transient data, and the like.

The system manager nodes 1 and 2, collectively, and CAN1-CAN3 execute a configuration management (CM) process that sets up each node with the appropriate software and configuration data upon initial start-up or after a reboot. Every node in the system also executes a node monitor (NM) process that loads software and tracks processes to determine if any process has failed. System manager nodes 1 and 2 execute a first arbitrary process, P1, and system manager node 1 also executes a second arbitrary process, P2.

In accordance with the principles of the present invention, call application nodes 1-3 (CAN1-CAN3) execute a number of call process (CP) server applications organized as primary and backup processes that are available as distributed group services to 1 to N call process client (CPC) applications, namely CPC APP1-CPC APPn in main processing unit 110. The N call application nodes (e.g., CAN1-CAN3) are separate computing nodes comprising a processor and memory that provide scalability and redundancy by the simple addition of more call application nodes.

Each of the N call process client (CPC) applications, namely CPC APP1-CPC APPn in MPU 110 handles the control signals and messages related to a single call associated with a mobile station. Each of CPC APP1-CPC APPn establishes a session with a mapped resource group, which assigns the call to a particular one of the primary-backup group call process server applications, CP1, CP2, or CP3. The selected call process server application actually performs the call process services/functions requested by the call process client application.

In the illustrated embodiment, three exemplary call process server applications are being executed, namely CP1, CP2, and CP3. Each of these processes exists as a primary-backup group. Thus, CP1 exists as a primary process, CP1p, and a backup process, CP1b. Similarly, CP2 exists as a primary process, CP2p, and a backup process, CP2b, and CP3 exists as a primary process, CP3p, and a backup process, CP3b. In the illustrated embodiment, CP1p and CP1b reside on different call application nodes (i.e., CAN1 and CAN2). This is not a strict requirement: CP1p and CP1b may reside on the same call application node (e.g., CAN1) and still provide reliability and redundancy for software failures of the primary process, CP1p. However, in a preferred embodiment of the present invention, the primary process and the backup process reside on different call application nodes, thereby providing hardware redundancy as well as software redundancy. Thus, CP1p and CP1b reside on CAN1 and CAN2, CP2p and CP2b reside on CAN2 and CAN3, and CP3p and CP3b reside on CAN3 and CAN1.

Together, CP1, CP2 and CP3 form a supergroup for load sharing purposes. Thus, CP1p and CP1b, CP2p and CP2b, and CP3p and CP3b are part of a first mapped resource group (MRG1), indicated by the dotted line boundary. Additionally, CAN1-CAN3 host three other mapped resource groups, namely, MRG2, MRG3, and MRG4. MRG2 comprises two idle list server (ILS) applications, namely ILS1 and ILS2. ILS1 exists as a primary process, ILS1lp, on CAN2 and a backup process, ILS1b, on CAN3. ILS2 exists as a primary process, ILS2p, on CAN3 and a backup process, ILS2b, on CAN2. Similarly, MRG3 comprises two identity server (IS) applications, namely IS1 and IS2. IS1 exists as a primary process, IS1p, on CAN1 and a backup process, IS1b, on CAN2 and IS2 exists as a primary process, IS2p, on CAN2 and a backup process, IS2b, on CAN1. Finally, MRG4 comprises two subscriber database (SDB) server applications, namely SDB1 and SDB2. SDB1 exists as a primary process, SDB1p, on CAN2 and a backup process, SDB1b, on CAN3 and SDB2 exists as a primary process, SDB2p, on CAN3 and a backup process, SDB2b, on CAN2.

A group service provides a framework for organizing a group of distributed software objects in a computing network. Each software object provides a service. In addition, the group service framework provides enhanced behavior for determining group membership, deciding what actions to take in the presence of faults, and controlling unicast, multicast, and groupcast communications between members and clients for the group. A group utilizes a policy to enhance the behavior of the services provided by the group. Some of these policies include primary-backup for high service availability and load sharing for distributing the loading of services within a network.

Call process server applications, such as CP1-CP3, ILS1-ILS2, IS1-IS2, and SDB1-SDB2, located within a computing network provide services that are invoked by client applications, such as CPC APP1-CPC APPn. As shown in FIG. 1, the call process server applications are organized into primary-backup groups configured as a 1+1 type of primary-backup group. There are multiple numbers of these primary-backup groups and the exact number is scalable according to the number of processes and/or computing nodes (CANs) that are used. All of the primary-backup groups are themselves a member of a single mapped resource group (e.g., MRG1, MRG2, MRG3, MRG4).

It is important to note that while the call process client applications, CPC APP1-CPC APPn, are clients with respect to the call process server applications, CP1, CP2, and CP3, a server application may be a client with respect to another server application. In particular, the call process server applications CP1-CP3 may be clients with respect to the idle list server applications, ILS1 and ILS2, the subscriber database server applications, SDB1 and SDB2, and the identity server applications, IS1 and IS2.

A client application establishes an interface to the mapped resource group. When a new call indication is received by the client application, the client application establishes a session with the mapped resource group according to a client-side load sharing policy. The initial server (CP1, CP2, etc.) selection policy is CPU utilization-based (i.e., based on the processor load in each of the candidate CANs, with more lightly loaded groups selected first), but other algorithmic policies, such as round-robin (i.e., distribution of new calls in sequential order to each CAN) may be used.

The client application associates the session with the new call and sends messages associated with the call over the session object. The client application also receives messages from the primary-backup group via the session established with the primary-backup group. Only the primary process (e.g., CP1p) of the primary-backup group joins the mapped resource group (e.g., MRG1).

For a variety of reasons, the application containing the primary may be removed from service. With the removal of the primary member, the backup member becomes the primary and the server application is no longer a member of the mapped resource group. However, the client application(s) still maintain their session with the primary-backup group for existing calls. New calls are not distributed to the primary-backup group if it is not a member of the mapped resource group.

If the primary of the primary-backup group (PBG) should fail, the backup member is informed that the primary member has failed (or left) and then assumes the role of primary member. The responsibility for these actions must be performed by the server application. It is the responsibility of the group service to inform the backup member that the primary member has failed or left.

As part of an on-line software upgrade process, one or more applications containing primary-backup groups may be removed from service, brought down, and then brought back up using a new version of software code. These groups, if their interface has not changed, join the existing mapped resource group. When first started, it is required that the client interface be capable of throttling the call traffic to specific primary-backup groups. The traffic throttling is expressed as a percentage varying from 0% (no calls) to 100%. New calls that would have been scheduled according to the scheduling algorithm are handled by this session. The throttling factor is initialized to 100% for any primary-backup group that joins the mapped resource group.

During on-line software upgrades, the throttling factor is adjusted to start with the no-calls case for the new software version. Any client application for the mapped resource group may establish a session with a specific primary-backup group. The client may then change the throttling factor at any time. When the throttling factor is changed, all client session interfaces receive via multicast the changed throttling factor. As the throttling factor is increased, the call process server applications with the new software version may receive increasing amounts of call traffic.

Call processing communications from the client applications to the call processing server primary-backup groups must support a very high volume of calls. The group software utilizes an internal transport consisting of a multicasting protocol (simple IP multicast) and optionally a unicasting protocol. The unicasting protocol may be TCP/IP, SCTP, or other transport protocol. The multicast protocol is used for internal member communications relating to membership, state changes, and fault detection.

In the absence of unicast transport, the multicast protocol is used for client/server communication streams. The unicast protocol, when provided, is used to provide a high-speed stream between clients and servers. The stream is always directed to the primary of a primary-backup group, which is transparent to both the call processing client application and the call process (e.g., CP1, CP2, CP3, ILS1, ILS2, IS1, IS2, SDB1, SDB2).

New call application nodes (CANs) and additional primary-backup group server applications (e.g., CP1, CP2, CP3, ILS1, ILS2, IS1, IS2, SDB1, SDB2) may be added dynamically to the mapped resource groups and can start servicing new call traffic. Call process client applications are not affected by the additions of new servers. If a server should fail, its backup assumes responsibility for the load. This provides high availability for the servicing of each call and minimizes dropped calls.

As noted above, however, not all tasks in a switch or router may be performed by distributed server applications in load-sharing groups. In many cases, a call processing task may be performed by only a single primary-backup group server application running on a single call application node (e.g., CAN1 or reference partition). If an upgraded server application is installed on a different node (e.g., CAN2 or new partition), the upgraded server application will not be able to take over all requests from call process client applications. This is because the old server application in the reference partition (CAN1) holds all data for existing calls and services and this information cannot be transferred between call application nodes because the call process client applications were initialized with the old server application.

To overcome this problem, telecommunication device 100 implements upgrade adaptor groups for upgrading such centralized server applications. Proxy objects associated with the primary members of the upgraded server application and the old server application join an upgrade adaptor group (UAG) which handles client requests. Since the client applications form associations with the proxy objects in the UAG rather than with the primary members of the primary-backup groups, resources may be migrated from a primary member of a first primary-backup group to a primary member of a second primary-backup group via the proxy objects without disturbing the associations with the client applications.

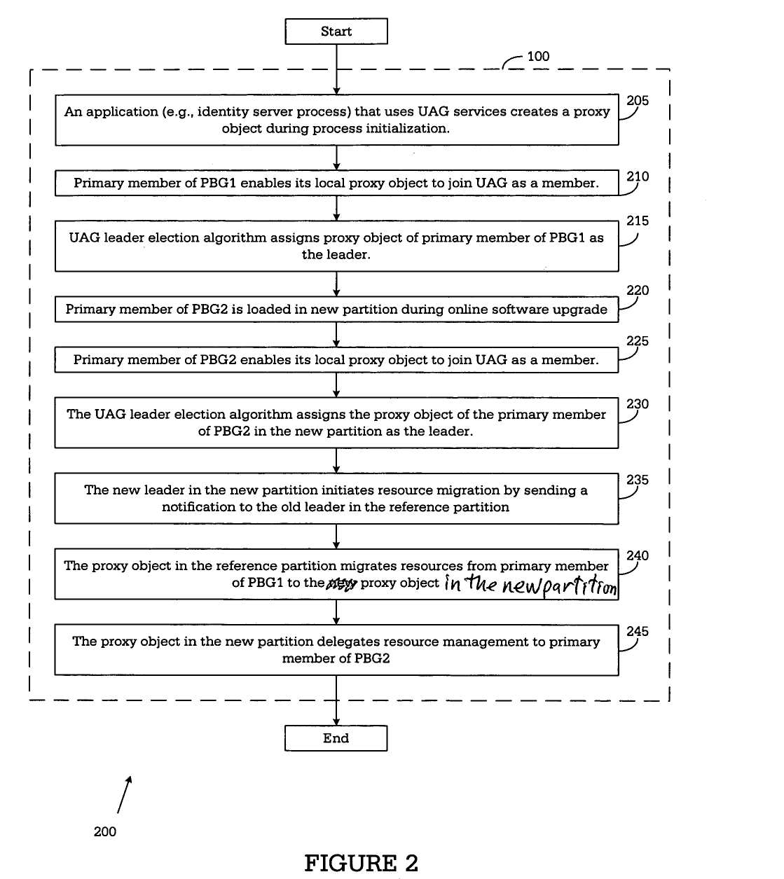

FIG. 2 depicts high-level flow diagram 200, which illustrates the use of proxy objects to perform on-line upgrades in upgrade adaptor groups according to the principles of the present invention. Initially, a primary member of a first primary-backup group server application (PBG1) that uses upgrade adaptor group (UAG) services creates a proxy object during process initialization (process step 205). This occurs in a first call application node (or reference partition), such as CAN1, for example. The primary member of the primary-backup group (PBG1) then enables its local proxy object to join the upgrade adaptor group (UAG) as a member (process step 210). The proxy object then performs a UAG election algorithm that assigns the proxy object as the leader of the UAG. All client requests are serviced by the leader of the UAG group (process step 215).

During an upgrade operation, a primary member of a second primary-backup group server application (PBG2) is loaded into a second call application node (or new partition), such as CAN2, for example (process step 220). The primary member of the second primary-backup group (PBG2) then enables its local proxy object to join the upgrade adaptor group (UAG) as a member (process step 225). The proxy object for the primary member of PBG2 then performs a UAG election algorithm that assigns the itself as the new leader of the UAG (process step 230). Thus, the leader selection algorithm always elects the newest member as leader. Thereafter, all new client requests are serviced by the proxy object for the primary member of PBG2. For the time being, requests from existing client applications continue to be serviced by the old leader (i.e., the proxy object for the primary member of PBG1).

Next, the new leader (i.e., the proxy object for the primary member of PBG2) in the new partition (i.e., CAN2) initiates resource migration by sending a notification to the old leader (i.e., the proxy object for the primary member of PBG1) in CAN1, the reference partition (process step 235). The proxy object for the primary member of PBG1 migrates resources from the primary member of PBG1 to the proxy object for the primary member of PBG2 (process step 240). The proxy object for the primary member of PBG2 then delegates resource management to the primary member of PBG2 (process step 245).

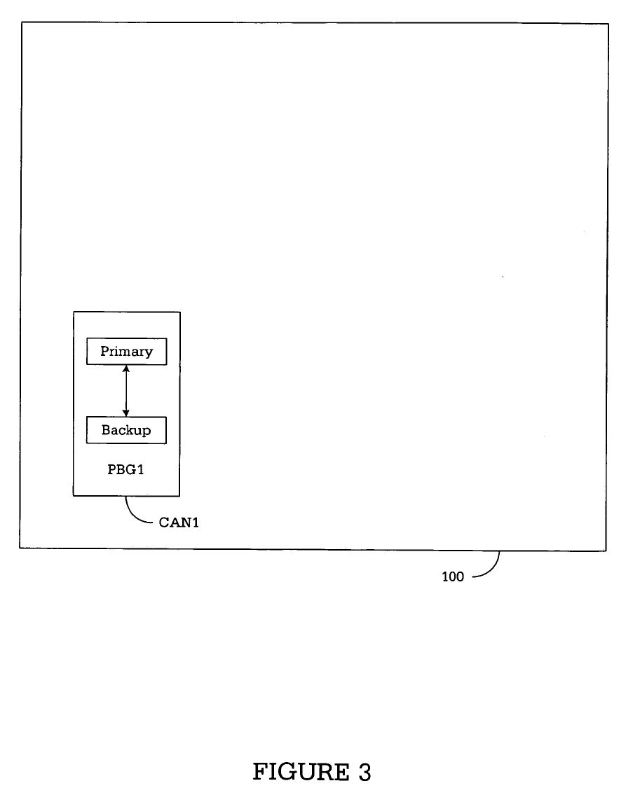

FIGS. 3-6 illustrate selected portions of an on-line upgrade operation in greater detail according to an exemplary embodiment of the present invention. Initially, an Operations Administration Maintenance and Provisioning (OAM&P) configuration manager (CM) directs a node monitor (NM) to load a server application capsule from database 120 into CANl. CAN1 is the reference partition. The server application may be, for example, an identity server process. As shown in FIG. 3, a first primary-backup group (i.e., PBG1) is created and a primary member object joins PBG1 group. Since the primary is the first member in PBG1, it is designated as the primary member. As PBG1 group is created, it is detected by the CM client in the system manager node (e.g., SYSMGR1). The creation event triggers the staffing of the backup member of PBG1.

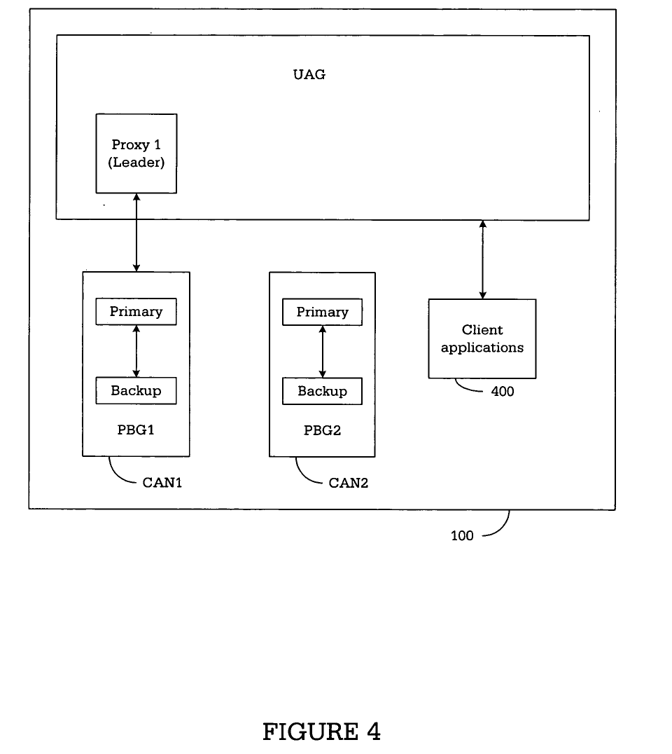

As shown in FIG. 4, upon receiving notification from the UAG group service application that it is the primary, the primary member of PBG1 creates a proxy object (i.e., Proxy 1). Proxy 1 creates update the Upgrade Adaptor Group (UAG) and joins UAG as a member. Since Proxy 1 is the newest member of the UAG, the leader election algorithm elects Proxy 1 as the Leader. The Leader retrieves identity server data from network database 120 and delegates resource management to the primary member of PBG1. At this time point, the primary member of PBG1 is capable of handling identity server requests received from client applications 400. The backup member of PBG1 is loaded and equalized with the primary member of PBG1.

Next, an upgrade server capsule is loaded in CAN2. CAN2 is the new partition. A second primary-backup group (PBG2) is created and the primary member of PBG2 joins PBG2 group. The primary member of PBG2 is designated as the primary because it is the first member in PBG2. As PBG2 group is created, it is detected by the CM client in SYSMGR1. The creation event triggers the staffing of the backup member of PBG2.

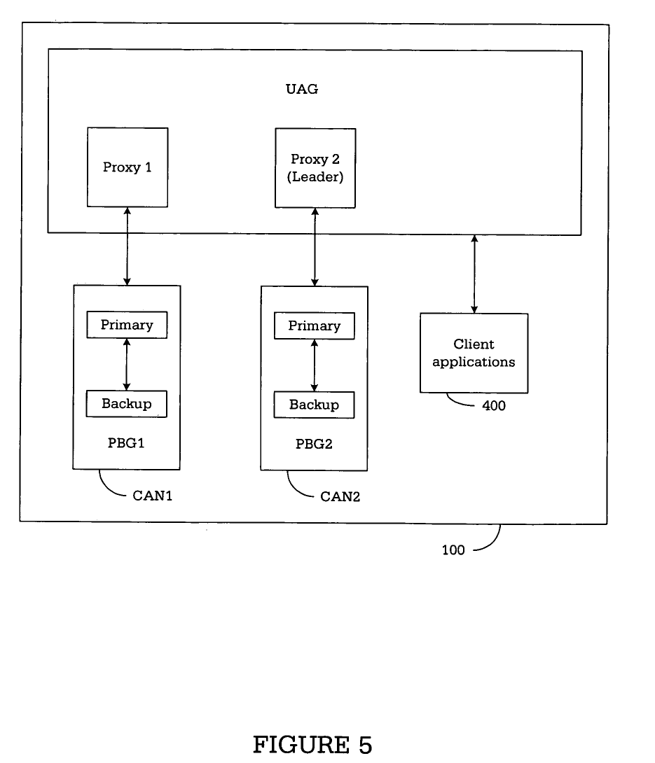

As shown in FIG. 5, upon receiving notification from the group service that it is the primary, the primary member of PBG2 creates a second proxy object (Proxy 2). Proxy 2 locates the UAG and joins the UAG as a member. Since Proxy 2 is the newest member of the UAG, the leader election algorithm elects Proxy 2 as the Leader. After receiving the resource allocation, Proxy 2 delegates resource management to the primary member of PBG2. At this point, the primary member of PBG2 is capable of handling identity server requests received from client applications 400. The backup member of PBG2 is loaded and equalized with the primary member of PBG2.

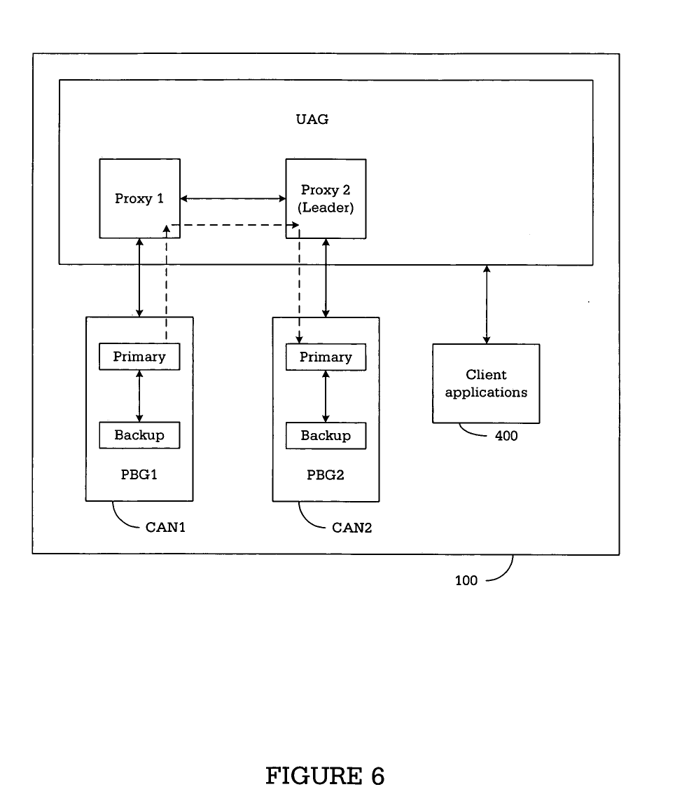

Finally, as shown in FIG. 6, resources controlled by the primary member in PBG1 are migrated to the primary member of PBG2 via Proxy 1 and Proxy 2. The resource migration is indicated by the dotted line in FIG. 6. At this time the on-line upgrade to PBG2 is complete and PBG1 can be shut down. The primary member of PBG2 then handles all requests from client applications 400.

Although the present invention has been described with an exemplary embodiment, various changes and modifications may be suggested to one skilled in the art. It is intended that the present invention encompass such changes and modifications as fall within the scope of the appended claims.

1. A telecommunication device capable of handling call connections between calling devices and called devices, said telecommunication device comprising:
a main processing unit capable of executing a plurality of client applications, wherein each of said client applications is associated with one of said call connections; and
a first call application node capable of executing a first primary server application, wherein the first primary server application comprises a first proxy object that is associated with an upgrade adaptor group and wherein said first proxy object provides services to said plurality of client applications in response to requests said plurality of client applications.

2. The telecommunication device as set forth in claim 1, wherein said first primary server application is associated with a similar first backup server application and wherein said first primary server application and said first backup server application form a first primary-backup group in which state information associated with said first primary server application is mirrored to said first backup server application.

3. The telecommunication device as set forth in claim 2, wherein said first backup server application is executed on one of said N call application nodes separate from said first call application node.

4. The telecommunication device as set forth in claim 3, wherein said first proxy object, upon joining said upgrade adaptor groups, is elected leader of said upgrade adaptor group to provide said services to said plurality of client applications.

5. The telecommunication device as set forth in claim 4, further comprising a second call application node capable of executing a second primary server application, wherein the second primary server application comprises a second proxy object that is associated with said upgrade adaptor group.

6. The telecommunication device as set forth in claim 5, wherein said second proxy object, upon joining said upgrade adaptor groups, is elected leader of said upgrade adaptor group.

7. The telecommunication device as set forth in claim 6, wherein said second proxy object provides said services to said plurality of client applications after said second proxy object is elected leader of said upgrade adaptor group.

8. The telecommunication device as set forth in claim 7, wherein said second proxy object migrates information from said first primary server application to said second primary server application after said second proxy object is elected leader of said upgrade adaptor group.

9. The telecommunication device as set forth in claim 6, wherein said second primary server application is associated with a similar second backup server application and wherein said second primary server application and said second backup server application form a second primary-backup group in which state information associated with said second primary server application is mirrored to said second backup server application.

10. The telecommunication device as set forth in claim 9, wherein said second backup server application is executed on one of said N call application nodes separate from said second call application node.

11. A communication network comprising a plurality of switching devices, each one of said switching devices capable of handling call connections between calling devices and called devices, said each switching device comprising:
a main processing unit capable of executing a plurality of client applications, wherein each of said client applications is associated with one of said call connections; and
a first call application node capable of executing a first primary server application, wherein the first primary server application comprises a first proxy object that is associated with an upgrade adaptor group and wherein said first proxy object provides services to said plurality of client applications in response to requests said plurality of client applications.

12. The communication network as set forth in claim 11, wherein said first primary server application is associated with a similar first backup server application and wherein said first primary server application and said first backup server application form a first primary-backup group in which state information associated with said first primary server application is mirrored to said first backup server application.

13. The communication network as set forth in claim 12, wherein said first backup server application is executed on one of said N call application nodes separate from said first call application node.

14. The communication network as set forth in claim 13, wherein said first proxy object, upon joining said upgrade adaptor groups, is elected leader of said upgrade adaptor group to provide said services to said plurality of client applications.

15. The communication network as set forth in claim 14, further comprising a second call application node capable of executing a second primary server application, wherein the second primary server application comprises a second proxy object that is associated with said upgrade adaptor group.

16. The communication network as set forth in claim 15, wherein said second proxy object, upon joining said upgrade adaptor groups, is elected leader of said upgrade adaptor group.

17. The communication network as set forth in claim 16, wherein said second proxy object provides said services to said plurality of client applications after said second proxy object is elected leader of said upgrade adaptor group.

18. The communication network as set forth in claim 17, wherein said second proxy object migrates information from said first primary server application to said second primary server application after said second proxy object is elected leader of said upgrade adaptor group.

19. A method for use in a telecommunication device comprising 1) a main processing unit for executing client applications; and 2) N call application nodes for executing server applications, the method comprising the steps of:
executing a first primary server application on a first call application node;
using a first proxy object associated with the first primary server application to join the first primary server application to an upgrade adaptor group, wherein the first proxy object enables the first primary server application to provide services to the client applications; and
installing an upgraded primary server application on a second call application node
using a second proxy object associated with the upgraded primary server application to join the upgraded primary server application to the upgrade adaptor group, wherein the second proxy object enables the upgraded primary server application to provide services to the client applications; and
in response the upgraded primary server application joining the upgrade adaptor group, the second proxy object provides services to the client applications in place of the first proxy object.

20. The method as set forth in claim 19, wherein the second proxy object migrates information from the first primary server application to the upgraded primary server application after the second proxy object joins the upgraded primary server application to the upgrade adaptor group.
